(19) United States
(12) Patent Application Publication
(10) Pub. No.: US 2020/0235596 A1
(43) Pub. Date: Jul. 23, 2020

(54) Provision Applied in Outlet with Source and Conjugated Male Load Connector

(71) Applicant: Darlineudo De Souza Rocha, Pacatuba (BR)

(72) Inventor: Darlineudo De Souza Rocha, Pacatuba (BR)

(21) Appl. No.: 16/751,185

(22) Filed: Jan. 23, 2020

(30) Foreign Application Priority Data
Jan. 23, 2019 (BR) 1020190012960

(51) Int. Cl. H02J 7/00; H01R 31/06; H01R 31/02

(52) U.S. Cl. CPC H02J 7/0045; H01R 31/02; H01R 31/065

(57) ABSTRACT

An innovative electrical outlet integrates a charging station and at least one receptacle to offer charging capability to electronic devices. Both the receptacle and the charging station snugly fit into a frame of the outlet. A flip cover of the charging station is pivoted on the frame, allowing a user to selectably flip the charging station normal to the frame to expose a charger mounted on the flip cover. The charger includes at least one male charger and at least one USB (universal serial bus) port, which conveniently connect to electronic devices with or without charging cables. With an output switching power supply board installed within the charger, the outlet can charge a variety of electronic devices with various voltage ratings. Further, the at least one receptacle can adapt to various electric apparatuses with different power connectors and supply a bi-volt electrical power source of 110 volts and 220 volts alternating current (AC).

The current application claims a priority to the Brazil Patent application number 1020190012960 filed on Jan. 23, 2019.

### FIELD OF THE INVENTION

The present invention relates generally to electrical outlets. More specifically, the present invention relates to an innovative outlet for supplying bi-volt power source such as 110 VAC (volts alternating current) and/or 220 VAC to electrical equipment and providing an angularly articulated charging station with at least one male charger to electronic devices.

### BACKGROUND OF THE INVENTION

As technology has advanceed over the years, the number of electrical and electronic devices that people use has increased considerably. Despite various studies to optimize the use and increase the life of batteries of these devices, there is still an almost daily need to recharge. Therefore, people always demand within reach recharge points for their devices. To satisfy this demand, there are already several models of outlets with one or more USB (Universal Serial Bus) inputs. To use these models, it is necessary that a user has the cable, otherwise, the user will not be able to connect a device to the USB port on the devices.

Many existing electrical outlets were descibed in prior arts. Brazil patent BR 202015 012 552-1—“UNIVERSAL WALL OUTLET,” belonging to the technical sector of electrical outlets, consists of a USB input with two switches to turn on and off lights or other devices, a voltage indication, pins input according to ABNT (The Brazilian Association of Technical Standards) standard, a universal input for pins in any country, an indication of the ground wire terminal, an amperage indication, a universal plug section according to ABNT standards, and an adapter, solving the problem of outlets manufactured in several countries that do not adapt in other countries. Another Brazil patent BR 20 2012 023186-2—“ELECTRICAL OUTLET WITH USB CHARGERS,” introduces an electrical outlet for the supply of electricity through a common electrical connector, which also contains electric chargers using USB-standard connectors. Comprised of a connector module for outlets in the Brazilian standard of common models found in the Brazilian market, besides counting on electronic circuits that supply power with a voltage of 5 volts, through USB-standard connectors, for the purpose of charging electronic devices powered by battery, as well as powering any other device that also uses this same voltage and connector as a power source. In BR 20 2017 02521-2—“IMPROVEMENTS INTRODUCED IN MULTIFUNCTION ELECTRICAL OUTLET,” the invention refers to a multifunctional electrical outlet that has a small general switch to cut off power when the appliances are off, in standby mode. Such a product was developed for energy saving and better adaptability to modern life, that is, in the same outlet, the user can get various functions such as USB input for (to charge cell phones, if the user forgot the charger), ethernet connection (for smart Televisions—TVs) and input for UHF (ultra-high frequency) and digital antenna. With this outlet, when the main switch is turned off, it will cut off all the energy flow to the appliances for a great energy saving and eliminates any possibility of the appliances being burned out due to lightning or excessive electric charges.

Although the documents cited in the above paragraph belong to the same technical field, the inventions thereof do not present the technical and functional characteristics of the present invention.

### SUMMARY OF THE INVENTION

The present invention provides an efficient and innovative electrical outlet, which integrates a charging station and at least one receptacle to offer electrical charging capability to electronic devices. The outlet has frame with a main opening, into which both the at least one receptacle and the charging station at a closed position snugly fit, thus giving the present invention an appearance similar to a regular outlet. A flip cover of the charging station is pivoted on the frame, allowing a user to selectably flip the charging station out of the frame and normal to the frame to expose a charger, which mounted on the flip cover. At this engaged position, the charging station provides convenient connections to electronic devices such as smart phones, tablets, smart watches, etc., for electrical charging.

The charger includes at least one male charger and at least one USB (universal serial bus) port, which conveniently connect to electronic devices with or without charging cables. Installed withing the charger, an output switching power supply board provides various direct current (DC) output, thus making the charger compatible with a variety of electronic devices with various DC voltage ratings. Further, the at least one receptacle can be adapted to various types of AC (alternating current) receptacle, enabling the present invention to supply power to various electric apparatuses with different power connectors and bi-volt such as 110 VAC and/or 220 VAC power source.

The invention differs from existing common outlets and the current outlets with at least one USB (universal serial bus) input and at least one male connector that can charge various electronic apparatuses, machines, and devices without the aid of an external cable. Using the angular articulation mechanism, the present invention allows pivoting the charging station into a closed position to conceal the charging station into the outlet. Thus, the present invention eliminates the requirement of a charging cable for charging various electronic devices by the exclusive use of common outlets with an internal output switching power supply board and a versatile charger mounted in such a way that it can be concealed when not in use and pulled out by means of angular articulation for charging purposes. The present invention embarks not only the mechanical and functional features, but also the shape, layout and strategic location of necessary parts and components that, correctly positioned, have brought a significant improvement of efficiency and effectiveness without entailing any onus to the user comparing with conventional electrical outlets.

### BRIEF DESCRIPTION OF THE DRAWINGS

FIG. 1 is a front view of the present invention.

FIG. 2 is an isometric perspective view of the present invention.

FIG. 3 is a rear view of the present invention.

FIG. 4 is a left-side view of the present invention.

FIG. 5 is a left-side perspective view of the present invention with a charging station being selectably pivoted to an engaged position.

FIG. 6 is an exploded perspective view of the present invention with the charging station being selectably pivoted to an engaged position.

FIG. 7 is a left-side view of the present invention with the charging station being selectably pivoted to an engaged position.

FIG. 8 is an exploded rear view of the present invention with the charging station being selectably pivoted to an engaged position.

FIG. 9 is a rear view of the present invention with the charging station being selectably pivoted to an engaged position.

FIG. 10 is front view of the present invention with the charging station being selectably pivoted to an engaged position and a personal electronic device being plugged into a male charger.

FIG. 11 is an electrical diagram of the present invention.

### DETAIL DESCRIPTIONS OF THE INVENTION

All illustrations of the drawings are for the purpose of describing selected versions of the present invention and are not intended to limit the scope of the present invention.

The present invention is an electrical outlet with a charging station which provides an efficient and effective means to a user to charge personal electronic devices without requiring charging cables. Based upon a traditional electrical outlet, the present invention facilities easy installation, retrofit, and/or replacement of existing outlets used in buildings including, but not limited to, residential, commercial, institutional facilities, etc. Additionally, the present invention incorporates a voltage output switching mechanism which makes the outlet compatible with bi-volt power including, but not limited to, 110 VAC (volts alternating current) to 220 VAC, and allows the present invention to supply electrical power to various apparatuses, machines, devices, etc. With a pivoting mechanism, the present invention conceals the charging station behind the outlet thus making the present invention function the same as a regular electrical outlet. By pulling the cover from the outlet and pivot to a position normal to the outlet, the user can plug in any desired electronic device to the charging station with or without a charging cable.

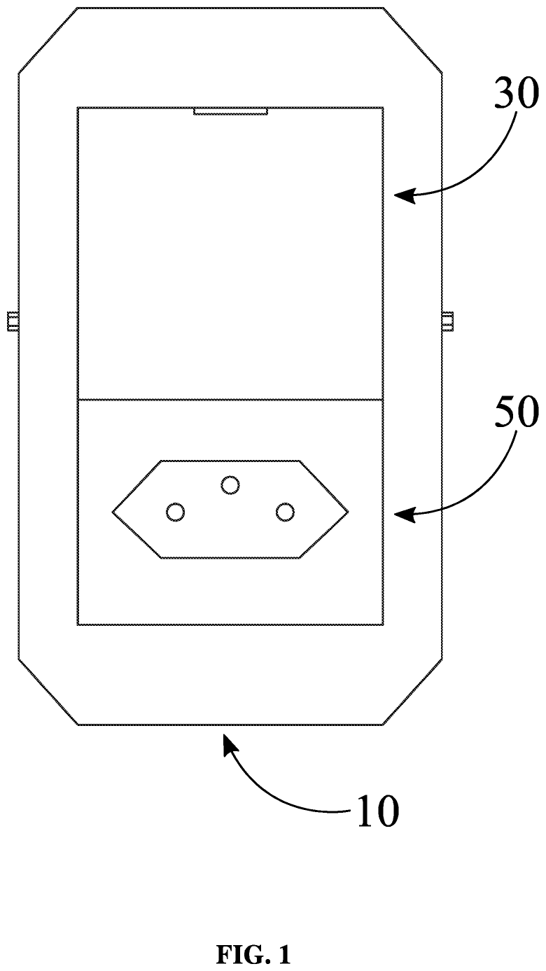

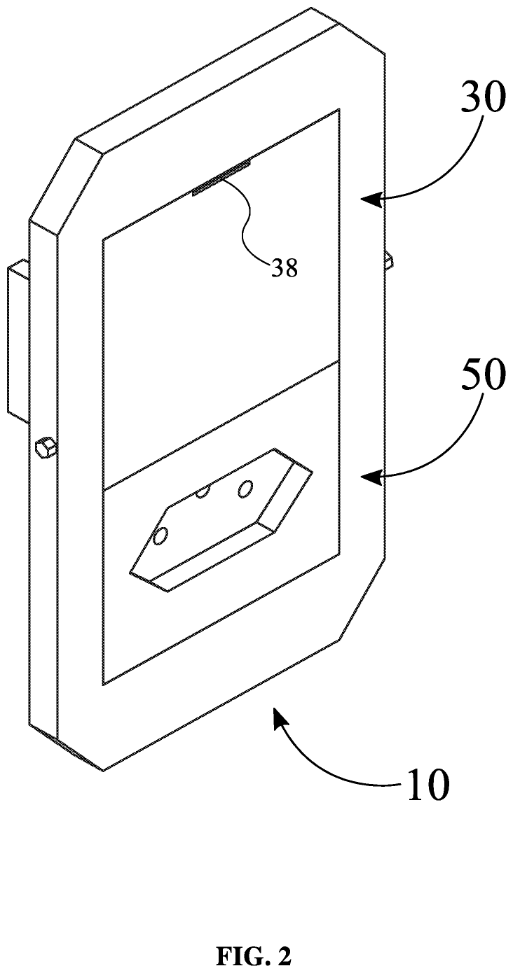

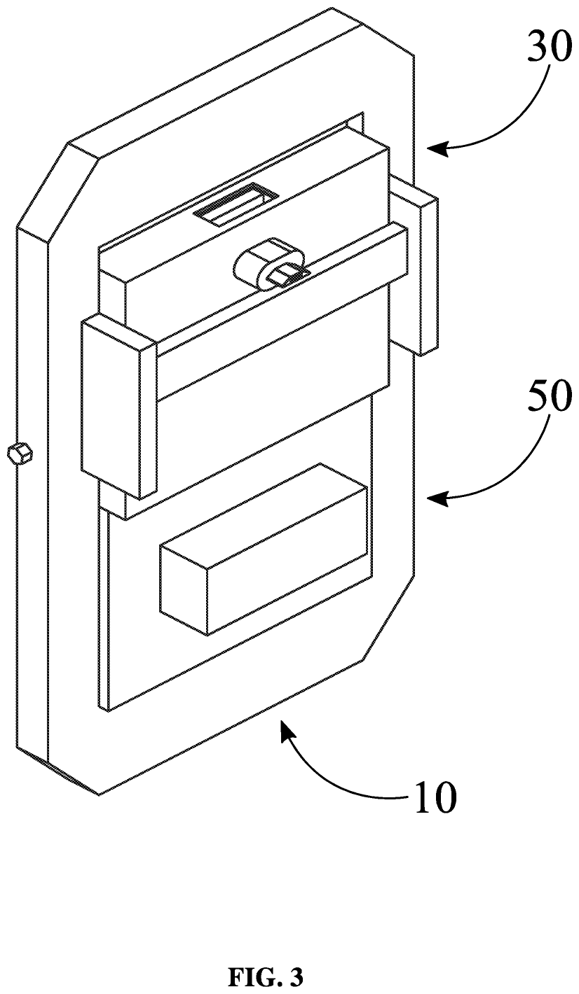

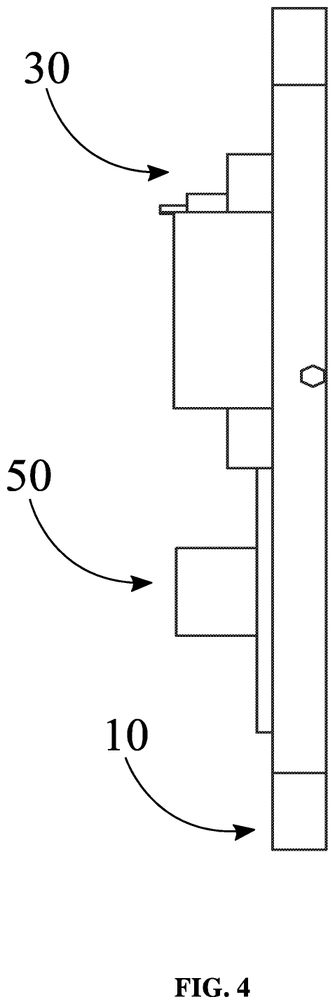

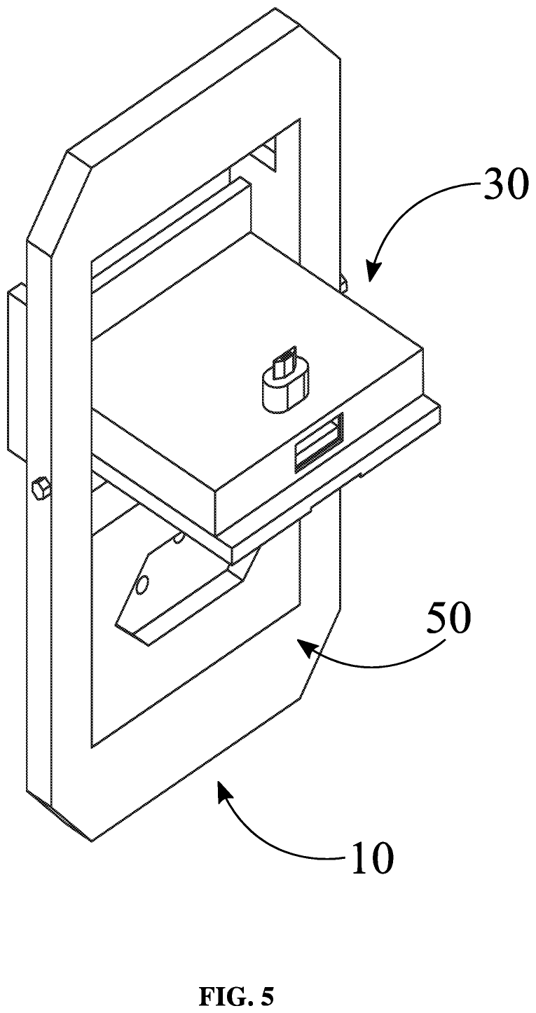

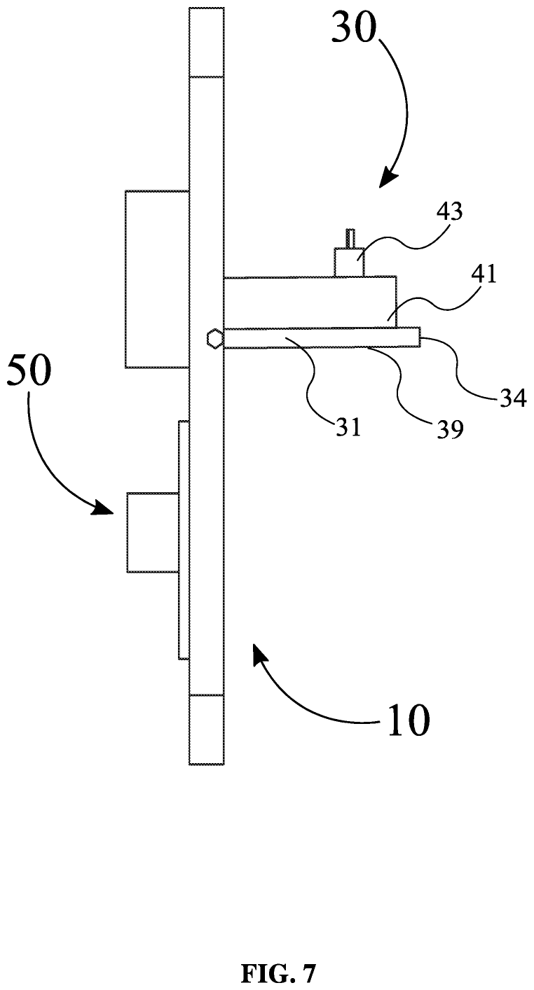

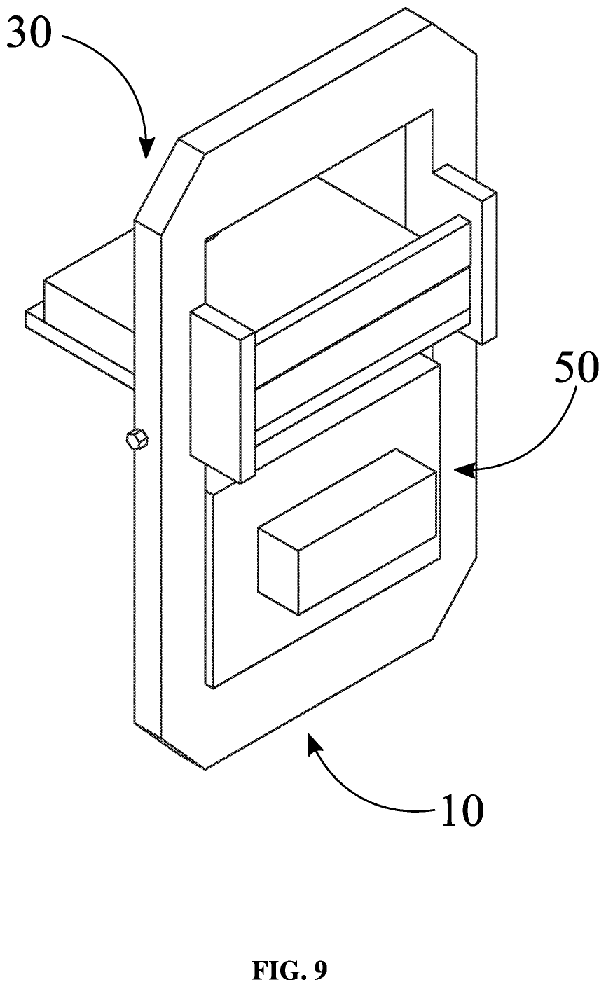

As can be seen in FIG. 1 to FIG. 11, the electrical outlet with a charging station of the present invention comprises an outlet plate 10, a charging station 30, and at least one receptacle 50. The outlet plate 10 comprises a frame 11 and a main opening 21. The main opening 21 is positioned on the frame 11, and the at least one receptacle 50 is mounted to frame 11. Additionally, the at least one receptacle 50 is positioned within the main opening 21 of the outlet plate 10. Further, the charging station 30 is pivotably mounted to the frame 11 of the outlet plate 10 and positioned within the main opening 21 of the outlet plate 10 adjacent the at least one receptable 50. The charging station 30 is concealed behind the frame 11 of the outlet pate 10 when the user selectably pivots the charging station 30 inside the main opening 21. In this position, as can be seen in FIG. 1 to FIG. 4, the present invention has an appearance similar to a regular electrical outlet. Whenever desired, the user can pull the top of the charging station 30 and pivot the charging station 30 to an engaged position that is approximately normal to the frame 11 of the outlet plate 10, as can be seen in FIG. 5 to FIG. 10. Additionally, the at least one receptacle 50 can receive at least one electrical device by supplying electrical power with a bi-volt AC power source including, but not limited to 110 VAC and/or 220 VAC. The outlet frame 10 may comprise a variety of shapes, including, but not limited to, square, rectangular, oval, circular, diamond, hexagon, etc. Additionally, the at least one receptacle 50 may comprise various shapes and can be any universal receptacle that is compatible with the physical construction in different countries, continents, etc. Further, the present invention may be made of any suitable material, including, but not limited to, plastic, polymer, aluminum, steel, stainless-steel, etc.

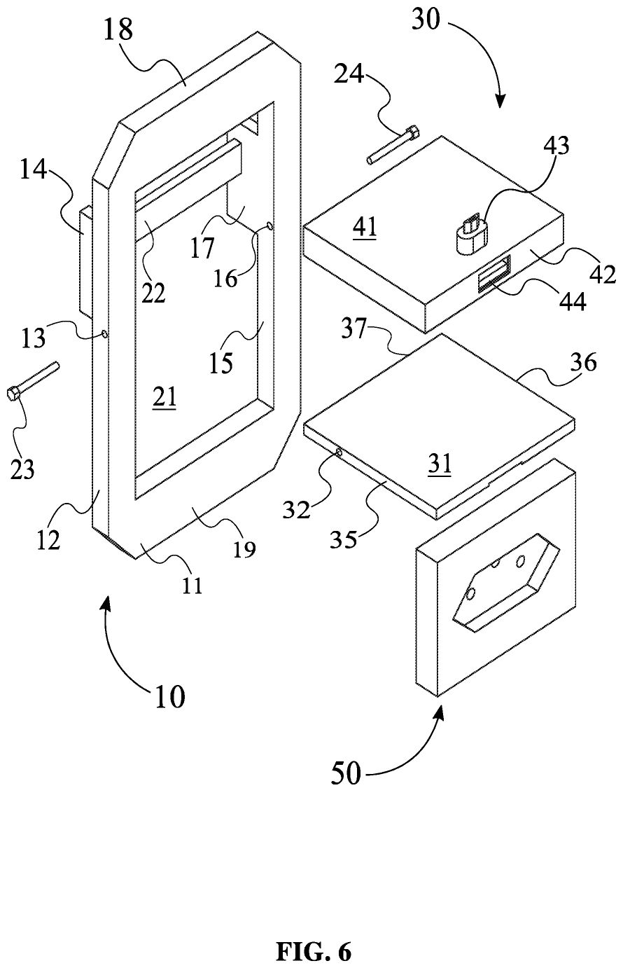

As can be seen in FIG. 6 to FIG. 9, the frame 11 of the outlet plate 10 comprises a first side 12, a second side 15, a top 18, a bottom 19, a first hole 13, a second hole 16, a first bracket 14, a second bracket 17, a back bracket 22, a first fastener 23, and a second fastener 24. The first hole 13, being a through hole, traverses the first side 12, while similarly, the second hole 16, also being a through hole, traverses the second side 15. The first bracket 14 is terminally attached to the first side 12 opposite the at least one receptacle 50. The first bracket 14 is positioned adjacent the first hole 13, and the second bracket 17 is attached to the second side 15 adjacent the second hole 16. The back bracket 22 is attached to both the first bracket 14 and the second bracket 17, supporting both the first bracket 14 and the second bracket 17 horizontally.

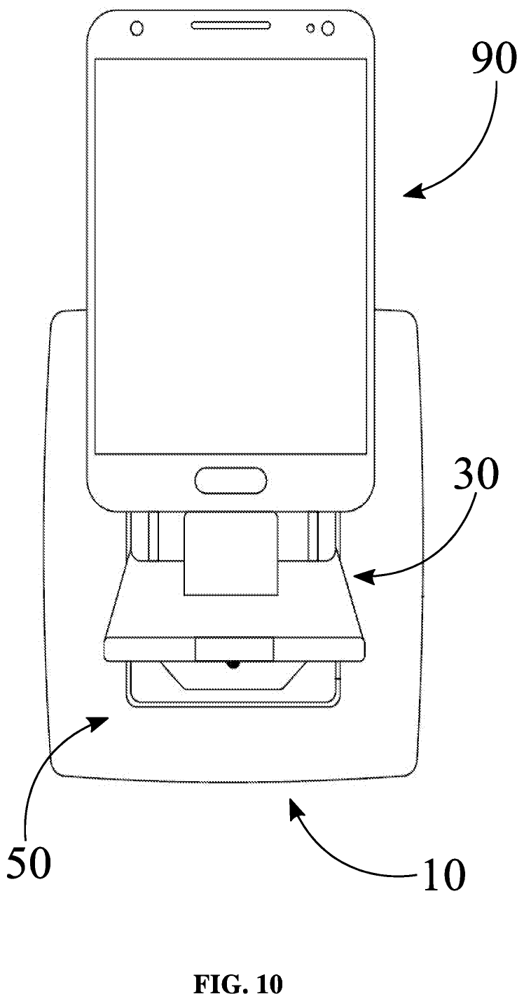

As can be seen in FIG. 6 to FIG. 8, the charging station 30 of the present invention comprises a flip cover 31 and a charger 41. The flip cover 31 comprises a front face 39, a top edge 34, a bottom edge 37, a first edge 35, a second edge 36, a first cover hole 32, a second cover hole 33, and a finger slot 38. The front face 39 is positioned flush with the frame 11 of the outlet plate 10 opposite both the first bracket 14 and the second bracket 17 of the outlet plate 10 when the charging station 30 is selectably concealed by the user thus the present invention appears like a regular electrical outlet. The top edge 34 is positioned adjacent the top 18 of the frame 11 of the outlet plate 10 while the bottom edge 35 is positioned adjacent the at least one receptacle 50. The first cover hole 32 is terminally positioned on the first edge 35 adjacent the bottom edge 37. The first fastener 23 of the frame 11 of the outlet plate 10 is mounted to the first cover hole 32 of the flip cover 31 through the first hole 13 of the frame 11. The second cover hole 33 is terminally positioned on the second edge 36 opposite the first cover hole 33. The second fastener 24 of the frame 11 of the outlet plate 10 is mounted to the second cover hole 33 of the flip cover 31 through the second hole 16 of the frame 11. Thus, the flip cover 31 is pivoted on the frame 11 of the outlet plate 10 through the first fastener 23 and the second fastener 24. Further, the flip cover 31 is configured to be selectably pivoted to two positions including, but not limited to, being flush with the frame 11 of the outlet plate 10 or being approximately normal to the frame 11 to expose the charger 41 for charging electronic devices. The finger slot 38 is positioned on the top edge 34 opposite the charger 41 which is mounted to the flip cover 31 opposite the front face 39. The charger 41 comprises a front edge 42, at least one male charger 43, at least one universal serial bus (USB) port 44, and a switching board 45. The front edge 42 is positioned adjacent the top edge 34 of the flip cover 31. The at least one USB port 44 is terminally mounted to the charger 41 at the front edge 42 and is positioned flush with the front edge 42 of the charger 41. The at least one male charger 43 is terminally attached to the charger 41 adjacent the front edge 42 and is positioned opposite the flip cover 31. When the charging station 30 is pivoted around the first fastener 23 and the second fastener 24 of the frame 11 of the outlet plate 10 using the finger slot 38 of the flip cover 31, both the at least one male charger 43 and the at least USB port 44 are selectably exposed for the user to charge at least one personal electronic device 90, as can be seen in FIG. 10.

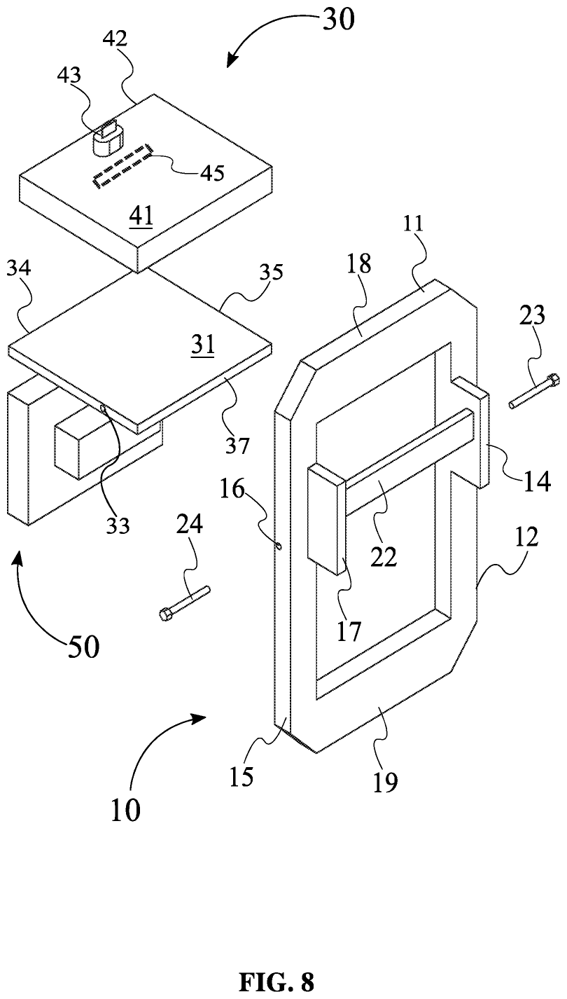

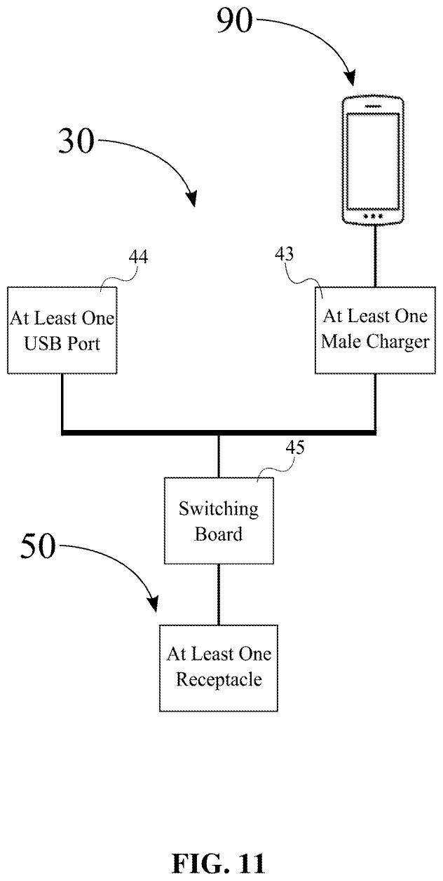

As can be seen in FIG. 8 and FIG. 11, the switching board 45 of the charger 41 of the charging station 30 is mounted within the charger 41 adjacent the at least one male charger 43, The switching board 45 is electrically connected to the at least one receptacle 50 and the at least one male charger 43. Additionally, the switching board 45 is electrically connected to the at least one USB port 44, as can be seen in FIG. 11. The switching board 45 is thus electrically connected to the charging station 30 and transforms alternating current to direct current. In some embodiment of the present invention, the switching board 45 may include, but is not limited to, a DC (direct current) output switching power supply board 5V (volt) DC output switching power supply board, or any suitable output switching power supply board.

Although the invention has been explained in relation to its preferred embodiment, it is to be understood that many other possible modifications and variations can be made without departing from the spirit and scope of the invention as hereinafter claimed.

What is claimed is:

1. An electrical outlet with a charging station for electronic devices comprising:
an outlet plate;
a charging station;
at least one receptacle;
the outlet plate comprising a frame and a main opening;
the main opening being positioned on the frame;
the at least one receptacle being mounted to frame;
the at least one receptacle being positioned within the main opening of the outlet plate;
the charging station being pivotably mounted to the frame of the outlet plate; and
the charging station being positioned within the main opening of the outlet plate adjacent the at least one receptable.

2. The electrical outlet with a charging station for electronic devices as claimed in claim 1, wherein the at least one receptacle receives at least one electrical device by supplying a bi-volt electrical power source of 110 volts and 220 volts alternating current (AC).

3. The electrical outlet with a charging station for electronic devices as claimed in claim 1, wherein the charging station is selectably pivoted to approximately normal to the outlet plate.

4. The electrical outlet with a charging station for electronic devices as claimed in claim 1, comprising:
the frame of the outlet plate comprising a first side, a second side, a top, a bottom, a first hole, a second hole, a first bracket, a second bracket, a back bracket, a first fastener, and a second fastener;
the first hole traversing the first side;
the second hole traversing the second side;
the first bracket being terminally attached to the first side opposite the at least one receptacle;
the first bracket being positioned adjacent the first hole;
the second bracket being attached to the second side adjacent the second hole; and
the back bracket being attached to both the first bracket and the second bracket;

5. The electrical outlet with a charging station for electronic devices as claimed in claim 4, comprising:
the charging station comprising a flip cover and a charger;
the flip cover comprising a front face, a top edge, a bottom edge, a first edge, a second edge, a first cover hole, a second cover hole, and a finger slot;
the front face being positioned flush with the frame of the outlet plate opposite both the first bracket and the second bracket;
the top edge being positioned adjacent the top of the frame of the outlet plate;
the bottom edge being positioned adjacent the at least one receptacle;
the first cover hole being terminally positioned on the first edge adjacent the bottom edge;
the first fastener of the frame of the outlet plate being mounted to the first cover hole of the flip cover through the first hole of the frame;
the second cover hole being terminally positioned on the second edge opposite the first cover hole;
the second fastener of the frame of the outlet plate being mounted to the second cover hole of the flip cover through the second hole of the frame;
the finger slot being positioned on the top edge opposite the charger;
the charger being mounted to the flip cover opposite the front face;
the charger comprising a front edge, at least one male charger, at least one universal serial bus (USB) port, and a switching board;
the front edge being positioned adjacent the top edge of the flip cover;
the at least one USB port being terminally mounted to the charger at the front edge;
the at least one USB port being positioned flush with the front edge of the charger;
the at least one male charger being terminally attached to the charger adjacent the front edge;
the at least one male charger being positioned opposite the flip cover;
the switching board being mounted within the charger adjacent the at least one male charger;
the switching board being electrically connected to the at least one receptacle;
the switching board being electrically connected to the at least one male charger;
the switching board being electrically connected to the at least one USB port;
wherein the charging station is pivoted around the first fastener and the second fastener of the frame of the outlet plate using the finger slot of the flip cover; and
wherein both the at least one male charger and the at least USB port are selectably exposed to charge at least one personal electronic device.

6. The electrical outlet with a charging station for electronic devices as claimed in claim 1, comprising:
the charging station comprising a switching board;
the switching board being installed within the charging station;
the switching board being electrically connected to the at least one receptacle;
the switching board being electrically connected to the charging station; and
wherein the switching board transforms alternating current to direct current.

7. An electrical outlet with a charging station for electronic devices comprising:
an outlet plate;
a charging station;
at least one receptacle;
the at least one receptacle being configured to supply a bi-volt electrical power source of 110 volts and 220 volts alternating current (AC);
the outlet plate comprising a frame and a main opening;
the main opening being positioned on the frame;
the at least one receptacle being mounted to frame;
the at least one receptacle being positioned within the main opening of the outlet plate;
the charging station being pivotably mounted to the frame of the outlet plate;
the charging station being positioned within the main opening of the outlet plate adjacent the at least one receptable;
the charging station comprising a flip cover and a charger;
the flip cover comprising a front face, a top edge, a bottom edge, a first edge, a second edge, a first cover hole, a second cover hole, and a finger slot;
the front face being positioned flush with the frame of the outlet plate opposite both the first bracket and the second bracket;
the top edge being positioned adjacent the top of the frame of the outlet plate;
the bottom edge being positioned adjacent the at least one receptacle;
the first cover hole being terminally positioned on the first edge adjacent the bottom edge;
the first fastener of the frame of the outlet plate being mounted to the first cover hole of the flip cover through the first hole of the frame;
the second cover hole being terminally positioned on the second edge opposite the first cover hole;
the second fastener of the frame of the outlet plate being mounted to the second cover hole of the flip cover through the second hole of the frame;
the finger slot being positioned on the top edge opposite the charger;
the charger being mounted to the flip cover opposite the front face;
the charger comprising a front edge, at least one male charger, and at least one universal serial bus (USB) port;
the front edge being positioned adjacent the top edge of the flip cover;
the at least one USB port being terminally mounted to the charger at the front edge;
the at least one USB port being positioned flush with the front edge of the charger;
the at least one male charger being terminally attached to the charger adjacent the front edge; and
the at least one male charger being positioned opposite the flip cover.

8. The electrical outlet with a charging station for electronic devices as claimed in claim 7, comprising:
the charger comprising a switching board;
the switching board being mounted within the charger adjacent the at least one male charger;
the switching board being electrically connected to the at least one receptacle;
the switching board being electrically connected to the at least one male charger;
the switching board being electrically connected to the at least one USB port;
wherein the charging station is pivoted around the first fastener and the second fastener of the frame of the outlet plate using the finger slot of the flip cover; and
wherein both the at least one male charger and the at least USB port are selectably exposed to charge at least one personal electronic device.
